(19) United States
(12) Patent Application Publication
(10) Pub. No.: US 2016/0146092 A1
(43) Pub. Date: May 26, 2016

(54) ENGINE SYSTEM HAVING COOLANT CONTROL VALVE

(71) Applicant: HYUNDAI MOTOR COMPANY, Seoul (KR)

(72) Inventor: Hyo Jo LEE, Suwon-si (KR)

(21) Appl. No.: 14/736,019

(22) Filed: Jun. 10, 2015

(30) Foreign Application Priority Data
Nov. 26, 2014 (KR) 10-2014-0166800

(51) Int. Cl. F01P 7/16; F02F 1/36; F01P 3/02

(52) U.S. Cl. CPC F01P 7/16; F01P 3/02; F02F 1/36; F01P 2003/024; F01P 2007/146

(57) ABSTRACT

An engine system having a coolant control valve includes a coolant pump pumps a coolant. A cylinder head receives the coolant by a first exhaust side water jacket and discharges the received coolant to a first intake side water jacket. An intake cylinder block receives the coolant by a second exhaust side water jacket and discharges the received coolant to a second intake side water jacket. A coolant control valve selectively blocks the coolant discharged from the first intake side water jacket of the cylinder head and the coolant discharged from the second intake side water jacket of the cylinder block, and separately controls coolants supplied to at least two heat exchangers. The heat exchangers include an oil cooler cooling oil, an exhaust gas recirculation (EGR) cooler cooling a recirculation exhaust gas, a heater core for indoor heating, or a radiator releasing heat of the coolant to outside.

### CROSS-REFERENCE TO RELATED APPLICATION

The present application claims the benefit of priority to Korean Patent Application Number 10-2014-0166800 filed on Nov. 26, 2014, the entire contents of which application are incorporated herein for all purposes by this reference.

### TECHNICAL FIELD

The present disclosure relates to an engine system having a coolant control valve capable of enhancing overall cooling efficiency and reducing fuel consumption by controlling a coolant flowing in an exhaust side and an intake side of a cylinder block and a cylinder head, respectively.

### BACKGROUND

An engine generates rotary power by combustion of fuel and discharges exhaust gas as thermal energy. In particular, a coolant, absorbs thermal energy and discharges the absorbed thermal energy while circulating through an engine, a heater, and a radiator.

When a temperature of the engine coolant is low, viscosity of oil may increase, thus increasing frictional force and fuel consumption. A temperature of the exhaust gas may increase gradually to lengthen a time to activate a catalyst and degrade quality of the exhaust gas. In addition, a time required for the heater to be normalized increases.

If the temperature of the coolant is too high, knocking is generated, and ignition timing needs to be adjusted to suppress generation of knocking, thus degrading performance. If a temperature of a lubricant is too high, a lubricating operation may be degraded.

Thus, a single coolant control valve is applied to control several cooling elements such that a temperature of the coolant in a particular portion is maintained to be high and a temperature of the coolant in another portion is maintained to be low.

Among the several cooling elements, a technique of separately cooling a cylinder block and a cylinder head has been researched.

The cylinder block and the cylinder head have an intake side for taking in ambient air having a relatively low temperature and an exhaust side for discharging the exhaust gas having a relatively high temperature, and studies have been conducted to uniformly control temperatures of the exhaust side and the intake side to enhance cooling efficiency and to reduce fuel consumption.

The above information disclosed in this Background section is only for enhancement of understanding of the background of the disclosure, and therefore, it may contain information that does not form the prior art that is already known in this country to a person of ordinary skill in the art.

### SUMMARY

The present disclosure has been made in an effort to provide an engine system having a coolant control valve having advantages of enhancing overall cooling efficiency of an engine and reducing fuel consumption by separately cooling a cylinder head and a cylinder block and uniformly cooling an intake side and an exhaust side of the cylinder head and the cylinder block.

An exemplary embodiment of the present inventive concept, an engine system having a coolant control valve includes a coolant pump that pumps a coolant. A cylinder head receives the coolant pumped by the coolant pump by a first exhaust side water jacket and discharges the received coolant to a first intake side water jacket. An intake cylinder block receives the coolant pumped by the coolant pump by a second exhaust side water jacket and discharges the received coolant to a second intake side water jacket. A coolant control valve selectively blocks the coolant discharged from the first intake side water jacket of the cylinder head and the coolant discharged from the second intake side water jacket of the cylinder block, and separately controls coolants supplied to at least two heat exchangers. The heat exchangers include an oil cooler cooling oil, an exhaust gas recirculation (EGR) cooler cooling a recirculation exhaust gas, a heater core for indoor heating, or a radiator releasing heat of the coolant to outside.

The coolant supplied to the first exhaust side water jacket of the cylinder head may flow to the first intake side water jacket, while flowing along the first exhaust side water jacket.

The coolant supplied to the second exhaust side water jacket of the cylinder block may flow to the second intake side water jacket, while flowing along the second exhaust side water jacket.

A first throttle bar may be installed on a coolant entrance side within the cylinder head in order to prevent the coolant introduced to the first exhaust side water jacket from flowing to the first intake side water jacket.

A second throttle bar may be installed on a coolant entrance side within the cylinder block in order to prevent the coolant introduced to the second exhaust side water jacket from flowing to the second intake side water jacket. The coolant control valve may include a cylindrical valve having a pipe shape with a space formed therein and coolant passages connected from the space to an outer side surface. A valve housing has an inner circumferential surface corresponding to an outer circumferential surface of the cylindrical valve, rotating the cylindrical valve with respect to a central axis, and having connection pipes formed to be connected to the heat exchangers, corresponding to the coolant passages. A driving unit is configured to rotate the cylindrical valve such that the coolant passages and the connection pipes respectively correspond to each other.

The engine system may further include sealing members interposed between the cylindrical valve and the valve housing such that the sealing members correspond to the connection pipes to seal the coolant.

The connection pipes may include a first connection pipe connected to the first intake side water jacket of the cylinder head to receive a coolant. A second connection pipe is connected to the EGR cooler and the heater core to supply a coolant. A third connection pipe is connected to the radiator to supply the coolant. A fourth connection pipe is connected to the second intake side water jacket of the cylinder block to receive the coolant. A fifth connection pipe is connected to the oil cooler to supply a coolant.

According to an embodiment of the present inventive concept, a coolant is supplied to the exhaust side of the cylinder head, the coolant is discharged to the intake side of the cylinder head, a coolant is supplied to the exhaust side of the cylinder block, the coolant is discharged to the intake side of the cylinder block, and the coolants discharged from the intake side of the cylinder head and from the intake side of the cylinder block are separately controlled, whereby a temperature of the engine is uniformly maintained overall, thus enhancing fuel efficiency and reducing fuel consumption.

### BRIEF DESCRIPTION OF THE DRAWINGS

FIG. 1 is a flowchart illustrating an overall flow of a coolant in an engine system having a coolant control valve according to an exemplary embodiment of the present inventive concept.

FIG. 2 is a partial schematic perspective view of the coolant control valve according to an exemplary embodiment of the present inventive concept.

FIG. 3 is a partial cross-sectional view of an engine according to an exemplary embodiment of the present inventive concept.

FIG. 4 is a perspective view illustrating a water jacket formed within a cylinder head and a cylinder block of the engine according to an exemplary embodiment of the present inventive concept.

FIG. 5 is a partial cross-sectional view of the coolant control valve related to the present inventive concept.

### DETAILED DESCRIPTION OF THE EMBODIMENTS

An exemplary embodiment of the present inventive concept will hereinafter be described in detail with reference to the accompanying drawings.

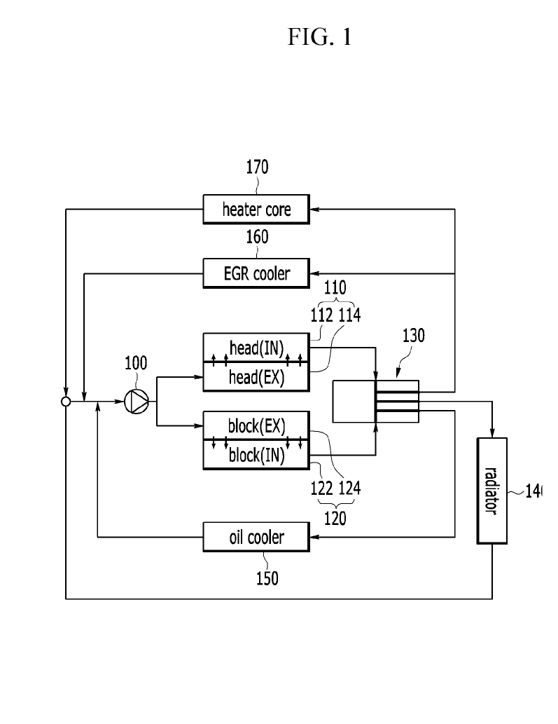

FIG. 1 is a flowchart illustrating an overall flow of a coolant in an engine system having a coolant control valve according to an exemplary embodiment of the present inventive concept.

Referring to FIG. 1, an engine system includes a coolant pump 100, a cylinder head 110, a cylinder block 120, a coolant control valve 130, and at least two heat exchangers including a radiator 140, an oil cooler 150, a heater core 170, and an exhaust gas recirculation (EGR) cooler 160.

The cylinder head 110 includes a first intake side water jacket 112 formed on an intake side and a first exhaust side water jacket 114 formed on an exhaust side. The cylinder block 120 includes a second intake side water jacket 122 formed on an intake side and a second exhaust side water jacket 124 formed on an exhaust side

The coolant pump 100 supplies a coolant to the first exhaust side water jacket 114 of the cylinder head 110, and the coolant supplied to the first exhaust side water jacket 114 flows from the first exhaust side water jacket 114 to the first intake side water jacket 112. The coolant is delivered from the first intake side water jacket 112 to the coolant control valve 130.

In addition, the coolant pump 100 supplies the coolant to the second exhaust side water jacket 124 of the cylinder block 120, and the coolant supplied to the second exhaust side water jacket 124 flows from the second exhaust side water jacket 124 to the second intake side water jacket 122. The coolant is delivered from the second intake side water jacket 122 to the coolant control valve 130.

The coolant supplied to the coolant control valve 130 is distributed to the heater core 170, the EGR cooler 160, the radiator 140, or the oil cooler 150 along coolant lines. The coolant which has passed through the heater core 170, the coolant which has passed through the EGR cooler 160, the coolant which has passed through the oil cooler 150, and the coolant which has passed through the radiator 140 circulate to an intake side of the coolant pump 100.

The heater core 170 serves to heat an indoor space of a vehicle using the circulating warm coolant, the EGR cooler 160 serves to cool a recirculation exhaust gas recirculating from an exhaust line to an intake line, the radiator 140 serves to outwardly discharge heat of the coolant, and the oil cooler 150 serves to cool oil circulating the cylinder head 110 or the cylinder block 120.

In an exemplary embodiment of the present inventive concept, a coolant supplied to one end portion of the first exhaust side water jacket 114 flows to another end portion of the first exhaust side water jacket 114, and here, the coolant flows from the first exhaust side water jacket 114 to the first intake side water jacket 112 in a width direction of the cylinder head 110.

A coolant supplied to one end portion of the second exhaust side water jacket 124 flows to another end of the second exhaust side water jacket 124, and here, the coolant flows from the second exhaust side water jacket 124 to the second intake side water jacket 122 in a width direction of the cylinder block 120.

In general, in the cylinder head 110 and the cylinder block 120, the exhaust side has a relatively high temperature distribution, and the intake side has a relatively low temperature distribution. Thus, the cylinder head 110 and the cylinder block 120 can be separately cooled, and the exhaust sides and intake sides of the cylinder head 110 and the cylinder block 120 can be sequentially cooled.

Since the cylinder head 110 and the cylinder block 120 are separately cooled and the intake sides and the exhaust sides thereof are uniformly cooled, combustion efficiency may be enhanced and the temperature distributions of the cylinder head 110 and the cylinder block 120 may become uniform, reducing frictional resistance of oil to reduce fuel consumption.

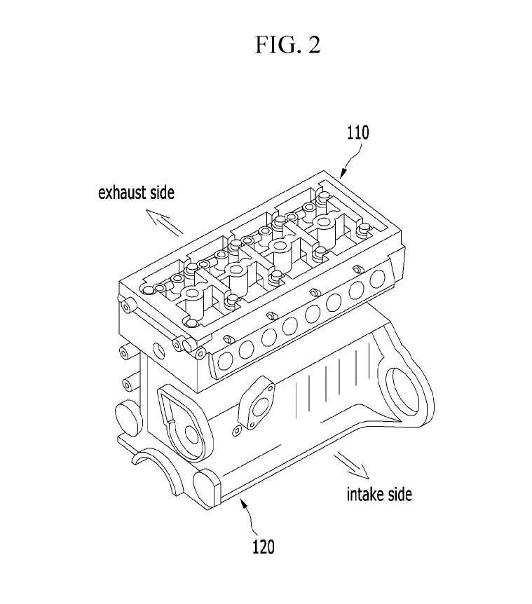

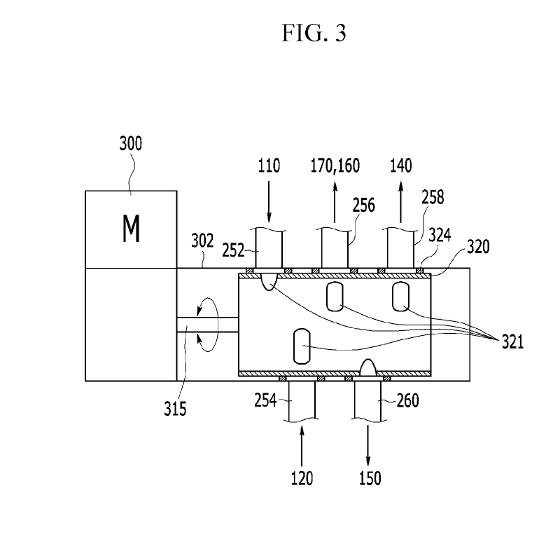

FIG. 2 is a partial schematic perspective view of the coolant control valve according to an exemplary embodiment of the present inventive concept. FIG. 3 is a partial cross-sectional view of an engine according to an exemplary embodiment of the present inventive concept.

Referring to FIGS. 2 and 3, the coolant control valve 130 includes a cylindrical valve 320, a valve housing 302, a rotational shaft 315, a sealing member 324, a first connection pipe 252, a second connection pipe 256, a third connection pipe 258, a fourth connection pipe 254, a fifth connection pipe 260, and a motor housing 300.

The cylindrical valve 320 has a pipe structure with a space formed therein and coolant passages 321 formed at preset positions to be connected from the space to an outer side surface. An inner circumferential surface of the valve housing 302 corresponds to an outer circumferential surface of the cylindrical valve 320, and the cylindrical valve 320 is rotatably disposed within the valve housing 302.

The motor housing 300 is disposed on one side of the valve housing 302, and a motor installed within the motor housing 300 is disposed to rotate the cylindrical valve 320 through the rotational shaft 315.

As illustrated, four coolant passages 321 are disposed in set positions in the cylindrical valve 320, the first connection pipe 252, the second connection pipe 256, the third connection pipe 258, the fourth connection pipe 254, and the fifth connection pipe 260 are connected to the valve housing 302, and sealing members 324 are interposed between the valve housing 302 and the cylindrical valve 320 such that the sealing members 324 correspond to connection pipes 252, 256, 258, 254, and 260, respectively.

The first connection pipe 252 is connected to the first intake side water jacket 112 of the cylinder head 110 to receive a coolant, the fourth connection pipe 254 is connected to the second intake side water jacket 122 of the cylinder block 120 to receive a coolant, and the coolant supplied to the first connection pipe 252 and the second connection pipe 256 is supplied through the coolant passages 321 of the cylindrical valve 320.

The second connection pipe 256 is connected to the EGR cooler 160 and the heater core 170, and supplies the coolant supplied to an inner side of the cylindrical valve 320 to the EGR cooler 160 and the heater cover 170 through the coolant passages 321.

The third connection pipe 258 is connected to the radiator 140 to supply the coolant supplied to the inner side of the cylindrical valve 320 to the radiator 140 through the coolant passage 321, and the fifth connection pipe 260 is connected to the oil cooler 150 to supply the coolant supplied to the inner side of the cylindrical valve 320 to the oil cooler 150 through the coolant passage 321.

In an exemplary embodiment of the present inventive concept, the coolant control valve 130 may block the coolant supplied to the cylinder head 110 and the cylinder block 120 according to rotational positions of the cylindrical valve 320 in a state in which the coolant is cold, thus maintaining a zero flow state.

In addition, when the coolant is overheated, the coolant control valve 130 may not block the coolant supplied from the cylinder head 110 and the cylinder block 120 and may circulate the coolant to the EGR cooler 160, the heater core 170, the radiator 140, and the oil cooler 150 according to rotational positions of the cylindrical valve 320.

According to the rotational positions of the cylindrical valve 320, the coolant control valve 130 may block the coolant supplied to the EGR cooler 160 and the heater core 170, block the coolant supplied to the radiator 140, and block the coolant supplied to the oil cooler 150.

Further, the cylinder head 110 includes an intake side on which an intake port is formed and an exhaust side on which an exhaust port is formed. The cylinder block 120 also includes an intake side and an exhaust side. In addition, the coolant pump 100 may be disposed in one end portion of the cylinder block 120, and the coolant control valve 130 may be disposed in the other portion of the cylinder block 120.

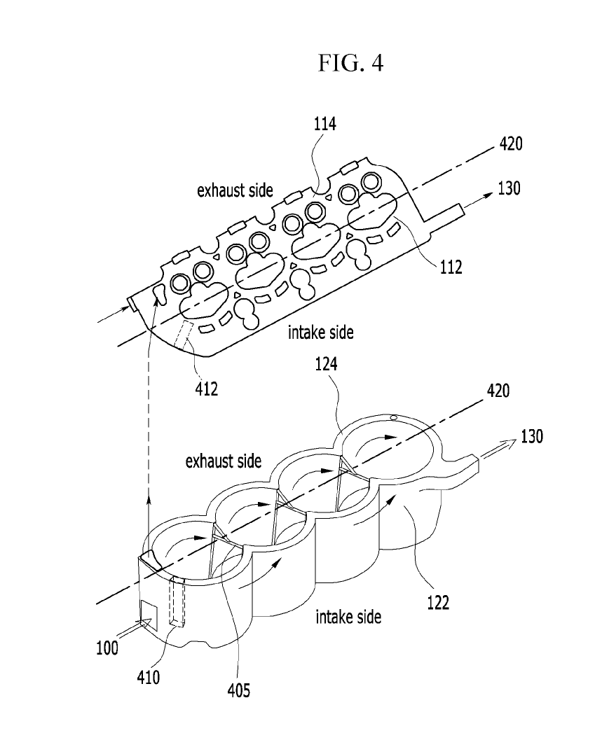

FIG. 4 is a perspective view illustrating a water jacket formed within a cylinder head and a cylinder block of the engine according to an exemplary embodiment of the present inventive concept.

Referring to FIG. 4, the first intake side water jacket 112 is formed within the cylinder head 110 to correspond to the intake side, and the first exhaust side water jacket 114 corresponds to the exhaust side. The first intake side water jacket 112 and the first exhaust side water jacket 114 may be configured as one body, and may be divided with respect to a central axis 420 of the cylinder head 110 in a length direction.

In addition, a first throttle bar 412 may be installed in the first intake side water jacket 112 in order to prevent the coolant supplied to the first exhaust side water jacket 114 from flowing to the first intake side water jacket 112.

The first throttle bar 412 is disposed on one side of a corner leading to the first intake side water jacket 112 from the first exhaust side water jacket 114, to allow the coolant to uniformly flow from the first exhaust side water jacket 114 to the first intake side water jacket 112 overall.

Referring to FIG. 4, a coolant jacket has the cylinder block 120 to correspond to each cylinder, and the coolant jacket includes a second intake side water jacket 122 corresponding to the intake side and a second exhaust side water jacket 124 corresponding to the exhaust side.

The second intake side water jacket 122 and the second exhaust side water jacket 124 may a single body, and may be divided with respect to the central axis 420 of the cylinder block 120 in the length direction.

In addition, a second throttle bar 410 may be installed in the second intake side water jacket 122 in order to prevent the coolant supplied to the second exhaust side water jacket 124 from flowing in quantity to the second intake side water jacket 122.

The second throttle bar 410 is disposed on one side of a corner leading to the second intake side water jacket 122 from the second exhaust side water jacket 124, to allow the coolant to uniformly flow from the second exhaust side water jacket 124 to the second intake side water jacket 122 overall.

A bridge passage 405 is formed in the middle of each cylinder to connect the second exhaust side water jacket 124 and the second intake side water jacket 122, and cools the narrow space in the cylinder.

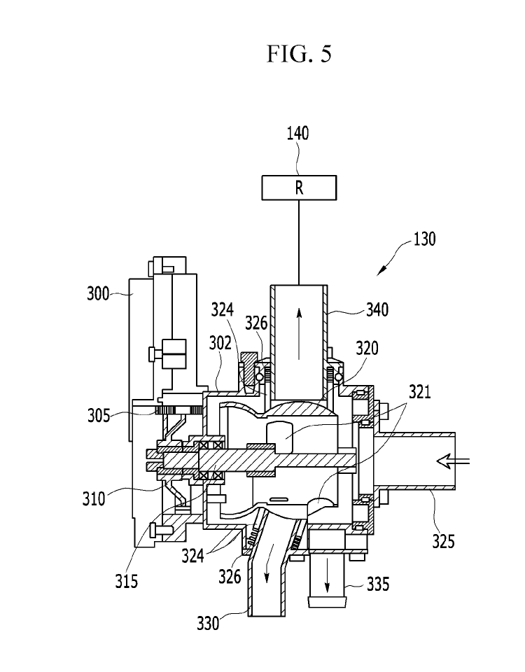

FIG. 5 is a partial cross-sectional view of the coolant control valve related to the present disclosure.

Referring to FIG. 5, the coolant control valve 130 includes the motor housing 300 in which the motor is installed, an output gear 305 rotated by the motor, and a passive gear 310 rotated by the output gear 305. The passive gear 310 rotates the cylindrical valve 320.

The cylindrical valve 320 has a pipe shape with both ends opened, and has a space formed in a central portion thereof in a length direction. A coolant passage 321 from the space of the central portion to an outer surface is formed in the cylindrical valve 320.

In the valve housing 302 in which the cylindrical valve 320 is installed, a first entrance pipe 325 is disposed in one end portion and the motor housing 300 is connected to another end portion thereof. In the valve housing 302, a radiator supply pipe 340 connected to the radiator 140, a second entrance pipe 330 connected to the cylinder head 110, and a heater supply pipe 335 connected to the heater are disposed.

A sealing member 324 is disposed on an outer circumferential surface of the cylindrical valve 320, a front end portion of the radiator supply pipe 340 is inserted into the sealing member 324, and an elastic member 326 elastically pushes the sealing member 324 toward an outer circumferential surface of the cylindrical valve 320 to form a sealing structure.

A controller (not shown) controls the motor within the motor housing 300 according to operation conditions, namely, a coolant temperature, an intake temperature, and the like, to rotate the cylindrical valve 320 with respect to the rotational shaft 315 disposed along the central axis of the cylindrical valve 320 in the length direction through the output gear 305 and the passive gear 310.

When the passages 321 of the cylindrical valve 320 correspond to the first entrance pipe 325 or the second entrance pipe 330, the coolant is supplied.

While this disclosure has been described in connection with what is presently considered to be practical exemplary embodiments, it is to be understood that the disclosure is not limited to the disclosed embodiments, but on the contrary, is intended to cover various modifications and equivalent arrangements included within the spirit and scope of the appended claims.

What is claimed is:

1. An engine system including a coolant control valve, the engine system comprising:
a coolant pump that pumps a coolant;
a cylinder head that receives the coolant pumped by the coolant pump by a first exhaust side water jacket and discharges the received coolant to a first intake side water jacket; and
a cylinder block that receives the coolant pumped by the coolant pump by a second exhaust side water jacket and discharges the received coolant to a second intake side water jacket, wherein
the coolant control valve is configured to selectively block the coolant discharged from the first intake side water jacket of the cylinder head and the coolant discharged from the second intake side water jacket of the cylinder block, and to separately control coolants supplied to at least two heat exchangers, and
the heat exchangers include an oil cooler cooling oil, an exhaust gas recirculation (EGR) cooler cooling a recirculation exhaust gas, a heater core for indoor heating, or a radiator releasing heat of the coolant to outside.

2. The engine system of claim 1, wherein the coolant supplied to the first exhaust side water jacket of the cylinder head flows to the first intake side water jacket, while flowing along the first exhaust side water jacket.

3. The engine system of claim 1, wherein the coolant supplied to the second exhaust side water jacket of the cylinder block flows to the second intake side water jacket, while flowing along the second exhaust side water jacket.

4. The engine system of claim 1, wherein the cylinder head has a first throttle valve on a coolant entrance side to prevent the coolant introduced to the first exhaust side water jacket from flowing to the first intake side water jacket.

5. The engine system of claim 1, wherein the cylinder block has a second throttle valve on a coolant entrance side to prevent the coolant introduced to the second exhaust side water jacket from flowing to the second intake side water jacket.

6. The engine system of claim 1, wherein the coolant control valve comprises:
a cylindrical valve having a pipe shape and having a space formed therein in which coolant passages are connected from the space to an outer side surface of the cylindrical valve;
a valve housing having an inner circumferential surface corresponding to an outer circumferential surface of the cylindrical valve, equipped with the cylindrical valve rotating with respect to a central axis, and having connection pipes connected to the heat exchangers to be correspond to the coolant passages; and
a driving unit configured to rotate the cylindrical valve such that the coolant passages and the connection pipes respectively correspond to each other.

7. The engine system of claim 6, further comprising sealing members interposed between the cylindrical valve and the valve housing such that the sealing members correspond to the connection pipes to seal the coolant.

8. The engine system of claim 6, wherein the connection pipes comprise:
a first connection pipe connected to the first intake side water jacket of the cylinder head to receive the coolant;
a second connection pipe connected to the EGR cooler and the heater core to supply the coolant;
a third connection pipe connected to the radiator to supply the coolant;
a fourth connection pipe connected to the second intake side water jacket of the cylinder block to receive the coolant; and
a fifth connection pipe connected to the oil cooler to supply the coolant.

9. The engine system of claim 6, wherein the driving unit includes a motor housing in which a motor is installed, an output gear rotating by the motor, and a passive gear rotating by the output gear—and rotating the cylindrical valve with respect to a rotational shaft disposed along a central axis of the cylindrical valve.

10. The engine system of claim 9, wherein the valve housing comprises:
a first entrance pipe connected to one end of the valve housing and the motor housing connected to another end thereof,
a radiator supply pipe connected to the radiator,
a second entrance pipe connected to the cylinder head, and
a heater supply pipe connected to the heater.

11. The engine system of claim 7, further comprising an elastic member elastically pushing the sealing member toward the outer circumferential surface of the cylindrical valve.
